(19) United States
(12) Patent Application Publication
(10) Pub. No.: US 2005/0009410 A1
(43) Pub. Date: Jan. 13, 2005

(54) Modular jack with anti-mismating mechanism for preventing incorrect insertion of a smaller sized plug

(76) Inventors: Yung Chang Cheng, Tu-Chen (TW); Kun Hua Chen, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/886,980

(22) Filed: Jul. 7, 2004

(30) Foreign Application Priority Data
Jul. 9, 2003 (TW) 92212595

(51) Int. Cl. H01R 24/00

(52) U.S. Cl. 439/676

(57) ABSTRACT

A modular jack (1), which permits insertion of a full sized plug and prevents insertion of a smaller sized plug, includes an insulative housing (10) having a receiving cavity (11) receiving a mating plug (3) through a front face thereof and a number of terminals (20) received in the receiving cavity (11) of the insulative housing (10). Each terminal (20) includes a contact portion (201) being inclinedly bent at an angle for extending into the receiving cavity (11), a soldering portion (203) and a raised portion (202) connecting the contact portion (201) with the soldering portion (203) and being vertical to a bottom wall of the receiving cavity (11).

### BACKGROUND OF THE INVENTION

1. Field of the Invention

The present invention relates to connectors, and especially to a modular jack designed to prevent improper insertion of smaller sized plug connector.

2. Description of the Prior Art

RJ-11 and RJ-45 receptacles respectively engaging with RJ-11 and RJ-45 plugs are commonly used in network communications. RJ-45 receptacles and plugs have larger dimensions than RJ-11 receptacles and plugs. Therefore, an RJ-11 plug or any smaller sized RJ type plug may be inadvertently inserted into an RJ-45 receptacle, which may result in damage to the terminals of the RJ-45 receptacle.

U.S. Pat. No. 6,416,364 B1 issued to Shi et al. on Jul. 9, 2002 disclosed a conventional receptacle connector having means to prevent incorrect insertion of a smaller sized plug so as to protect terminals of the receptacle connector. The Shi receptacle connector comprises an insulative housing and a terminal module received therein. The terminal module includes a base and a plurality of terminals insert molded with the base. The base includes a plurality of protruding ribs and a plurality of passages between every two protruding ribs. A corresponding plug includes a plurality of separating walls inserted respectively into the passages of the base of the housing. When a smaller sized plug is inserted into the modular jack, the width of the plug is smaller and the separating walls can not be fitted in the passages correspondingly. Therefore, the smaller sized plug is prevented from being inserted further. The anti-mismating means of the Shi receptacle connector is simple. But the rib of the receptacle connector enlarged the height of the housing and is not suitable under certain situation where the height of the connector is required critical.

### BRIEF SUMMARY OF THE INVENTION

An object of the present invention is to provide a modular jack with simple anti-mismating mechanism and low profile for preventing an improper insertion of an undersized plug.

A modular jack, which permits insertion of a full sized plug and prevents insertion of a smaller sized plug, comprises an insulative housing having a receiving cavity receiving a mating plug through a front face thereof and a plurality of terminals received in the receiving cavity of the insulative housing. Each terminal includes a contact portion being inclinedly bent at an angle for extending into the receiving cavity, a soldering portion and a raised portion connecting the contact portion with the soldering portion and being vertical to a bottom wall of the receiving cavity.

### BRIEF DESCRIPTION OF THE DRAWINGS

FIG. 1 is a perspective view of a modular jack according to the present invention.

FIG. 2 is a top view of the modular Jack of FIG. 1.

FIG. 3 is a cross sectional view taken along 3-3 of FIG. 2.

FIG. 4 is a perspective view of terminals of the modular Jack of FIG. 1.

FIG. 5 is a side view of one of the terminals of FIG. 4.

FIG. 6 is a perspective view of a mating plug mating with the modular Jack.

### DETAILED DESCRIPTION OF THE INVENTION

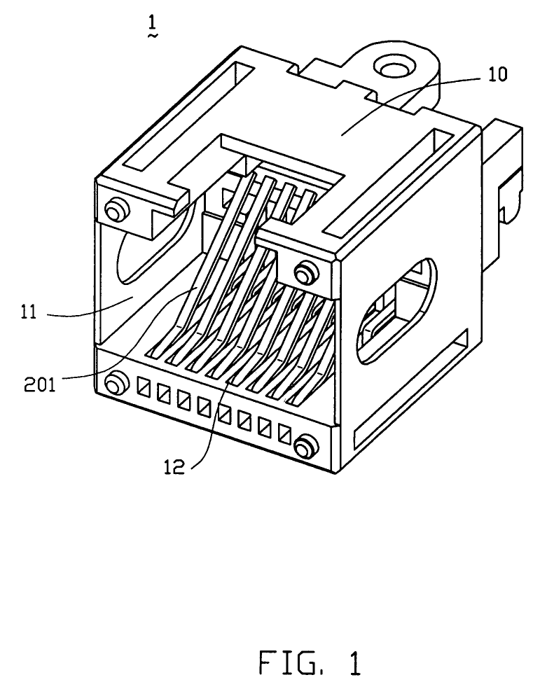

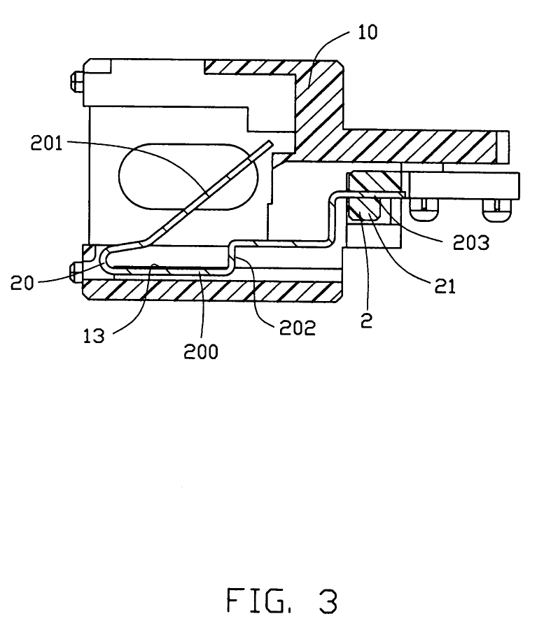

Referring to FIGS. 1 and 3, a modular jack 1 comprises an insulative housing 10 and a terminal insert 2 received in the housing 10.

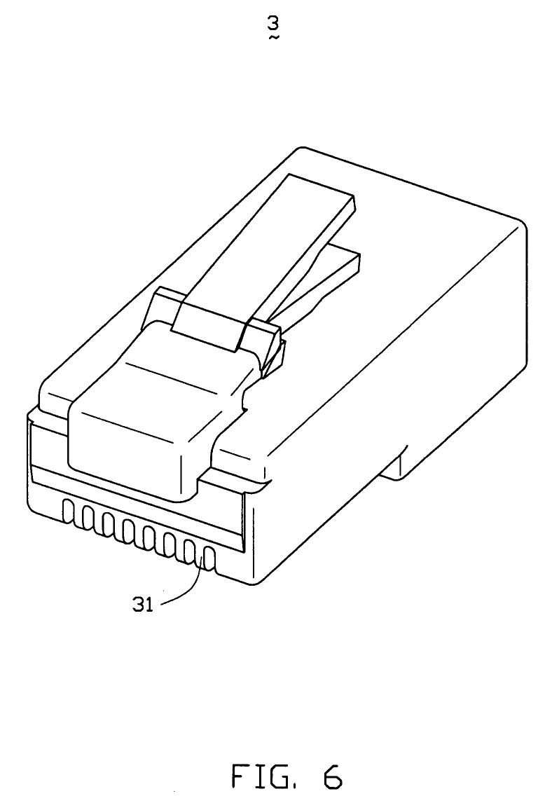

The housing 10 comprises a receiving cavity 11 for receiving a mating plug 3 (shown in FIG. 6) through a front face thereof. The housing 10 further comprises a plurality of channels 12 in communication with the receiving cavity 11, for accommodating the terminals 20, in a bottom wall (not labeled) thereof along an inserting direction of the mating plug 3. Each channel 12 forms a pair of flanges 13 in opposite sidewalls, in the insertion direction of the mating plug 3, for securing a corresponding terminal 20 therein.

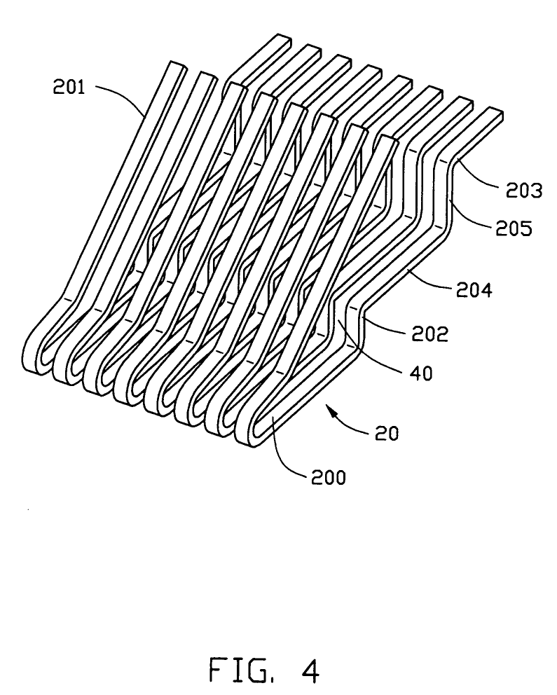

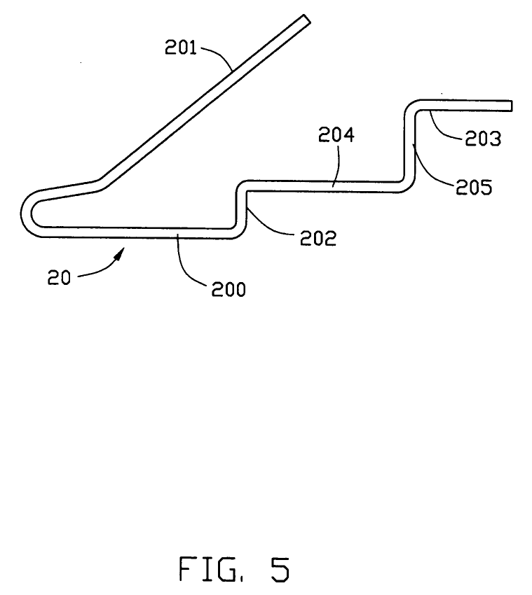

Referring FIGS. 3, 4 and 5, the terminal insert 2 includes an insulator 21 and a plurality of terminals 20 engaged with the insulator 21. Each terminal 20 includes a horizontal fixing portion 200, a spring contact portion 201 extending rearwardly at an acute angle from a front end of the fixing portion 200, a raised portion 202 extending vertically and upwardly from a rear end of the fixing portion 200, a connecting portion 204 extending rearwardly from an upper end of the raised portion 202, a second raised portion 205 extending upwardly from a rear end of the connecting portion 204, and a soldering portion 203 extending rearwardly from an upper end of the second raised portion 205. The soldering portions 203 are secured in the insulator 21, for example by insert molding process, and extend through the insulator 21 for connecting with a cable (not shown) or being connected to an exterior PCB (not shown).

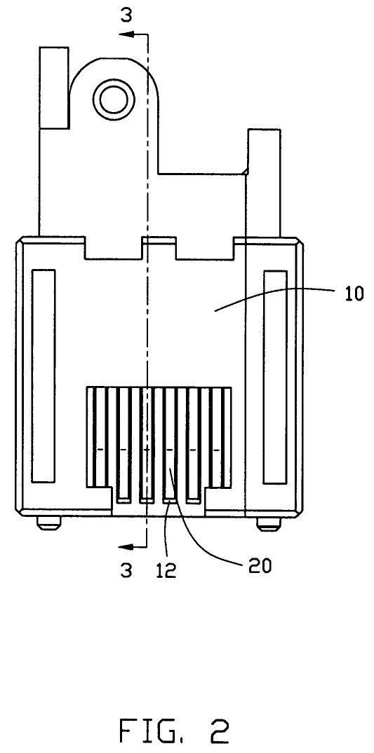

Referring to FIGS. 1, 2 and 3, during assembly, the terminal insert 2 is inserted into the housing 10 in a back-to-front direction through a rear opening (not labeled). Each fixing portion 200 of the terminals 20 is pressed under a pair of flanges 13 of a corresponding channel 12 to be secured in the channel 12. The contact portions 201 extend upwardly and rearwardly into the receiving cavity 11 for engaging with the mating plug 3. The raised portions 202 extend beyond an upper surface of bottom wall of the housing 10. The insulator 21 is secured in a rear portion of the housing 10.

Referring to FIG. 6, the mating plug 3 comprises a plurality of separating walls 31 and a plurality of male contacts (not shown) each between every two separating walls 31.

When the mating plug 3 is inserted into the modular jack 1, the separating walls 31 of the mating plug 3 are respectively situated between every two terminals 20 and the male contacts engage with corresponding contact portions 201 of the terminals 20, respectively.

An undersized plug (such as an RJ-11 plug, not shown) is inserted into the modular jack 1, owing to its smaller outer width than an inner width of the receiving cavity 11 of the modular jack 1, the undersized plug can be inserted into the modular jack 1. The undersized plug is further inserted into the modular jack 1, the separating walls 31 can not be received between every two terminals 20 correspondingly and come into engage with contact portions 201 of the terminals 20. The contact portions 201 deform elastically, and abut against the raised portions 202, thereby preventing further insertion of the undersized plug.

It is to be understood, however, further though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent identify by the broad general meaning of the terms in which the appended claims are expressed.

1. A modular jack for permitting insertion of a full sized plug and preventing insertion of a smaller sized plug, comprising:
an insulative housing having a receiving cavity through a front face thereof for receiving a mating plug; and
a plurality of terminals received in the receiving cavity of the insulative housing, each terminal including a contact portion being inclinedly bent at an angle and extending into the receiving cavity, a soldering portion and a raised portion between the contact portion and the soldering portion and vertical to a bottom wall of the receiving cavity.

2. The modular jack according to claim 1, wherein each terminal further includes a horizontal fixing portion, the contact portion extending rearwardly at an acute angle from a front end of the fixing portion, the raised portion extending vertically and upwardly from a rear end of the fixing portion.

3. The modular jack according to claim 2, wherein each terminal further includes a connecting portion extending rearwardly from an upper portion of the raised portion and a second raised portion extending upwardly from a rear end of the connecting portion, said solder portion extending rearwardly from an upper portion of the second raised portion.

4. The modular jack according to claim 3 further includes an insulator, said soldering portions of the terminals are secured with the insulator and extending through the insulator in a horizontal direction.

5. The modular jack according to claim 4, wherein the insulative housing includes a plurality of channels in a bottom wall of the cavity thereof, the fixing portions being received in the respective channels.

6. The modular jack according to claim 5, wherein each channel forms a pair of flanges on opposite sides thereof, the fixing portions of the terminals being secured by respective flanges.

7. A modular jack for permitting insertion of a full sized plug and preventing insertion of a smaller sized plug, comprising:
an insulative housing having a receiving cavity through a front face thereof for receiving a mating plug; and
a plurality of terminals received in the receiving cavity of the insulative housing, each terminal including a mating portion being inclinedly bent at an angle and extending into the receiving cavity, a tail portion opposite to the mating portion, and a raised portion between the mating portion and the tail portion; wherein the inclinedly bent mating portion abuts against the raised portion when the smaller sized plug is inserted into the cavity so that said smaller sized plug is prevented from being fully received in the cavity

8. The modular jack according to claim 7, wherein said tail portion is higher than the raised portion.

9. A modular jack assembly comprising:
a jack, a large sized plug and a small sized plug, said jack including:
an insulative housing having a receiving cavity through a front face thereof for receiving a mating plug; and
a plurality of terminals received in the receiving cavity of the insulative housing, each terminal including a mating portion being inclinedly bent at an angle and extending into the receiving cavity, a tail portion opposite to the mating portion, and an abutment portion between the mating portion and the tail portion;
the large sized plug defining a plurality of grooves corresponding to the terminals;
the small sized plug defining a plurality of grooves corresponding to only some of said terminals; wherein
when the large sized plug is inserted into the cavity, the mating portions of all the terminals can be received in the corresponding grooves without obstruction so as to allow the large sized plug to be fully received in the cavity; oppositely when the small sized plug is inserted into the cavity, the mating portions of said some of the terminals are received in the corresponding grooves while the mating portions of some of the remainder are stopped by the corresponding abutment portions so as to prevent the small sized plug from being fully received in the cavity.
